(19) United States
(12) Patent Application Publication
(10) Pub. No.: US 2008/0193650 A1
(43) Pub. Date: Aug. 14, 2008

(54) Method of remediation, cleaning, restoration and protection

(76) Inventor: William Morrison Lyon, Marletta, GA (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/704,278

(22) Filed: Feb. 8, 2007

Related U.S. Application Data
(60) Provisional application No. 60/771,381, filed on Feb. 8, 2006.

(51) Int. Cl. B05D 3/00; A01N 39/00; B08B 5/04; B08B 7/00; C11D 17/00

(52) U.S. Cl. 427/299; 134/21; 134/4; 424/616; 510/405; 8/111

(57) ABSTRACT

Concentrated hydrogen peroxide solution is utilized for biomass, biofilm and pathogen remediation and/or sterilization, disinfection, sanitizing, cleaning and/or removing soils from spaces or surfaces. Instead of utilizing diluted low concentration and pH slightly acidic to alkaline hydrogen peroxide, the applicant proposes the use of a formulated and concentrated hydrogen peroxide solution with preferably with an acidic pH such as about 3.5 along with low levels of inhibitors and/or the addition of activators such as ozone, iron, etc. Foaming occurs in many instances identifying treatment in progress and an anti-microbial solution can provide long term protection against re-growth.

### CLAIM OF PRIORITY

This application claims the benefit of U.S. Provisional Patent Application No. 60/771,381 filed Feb. 8, 2006, incorporated herein by reference.

### FIELD OF THE INVENTION

This invention relates to the remediation and/or destruction and/or removal of mold and/or other microorganisms and/or biofilms and/or contaminants from interior or exterior structures or environments including porous and nonporous surfaces, and additionally, the restoration of water and/or sun and/or stained or otherwise soiled damaged surfaces, especially porous surfaces such as wood, drywall, etc., and additionally, to a treatment which preferably inhibits the regrowth of such microorganisms in treated areas.

### BACKGROUND OF THE INVENTION

The current art of killing and removing mold from structures is believed to principally rely on the use of various cleaners and/or disinfectant formulations. Disinfectant formulations are typically sprayed or wiped on surfaces to be remediated. Wiping inanimate surfaces with wiping cloths soaked with disinfectant to kill and delay growing mold and their spores is one predominent method. The wiping rag typically removes mold and spores that attach to the rag. This technique often does not remove all surface contaminants. The wiping rags are then normally contained and then removed from the cleaning location. This is believed to be a long and laborious process that has no indicator where otherwise invisible microscopic contamination may remain or has been adequately treated. Disinfectants and/or cleaners which are currently used for remediation are not believed to be total-spectrum microbiology killing agents. There is not known by the applicant to be a single disinfectant currently used on the market for application kills of all microorganisms or targets and kills all mold species.

Cleaning HVAC systems, or other air or ventilation type system, normally characterized by hard to access areas is difficult with known techniques. In current practice, portions of ducting may be removed and/or cleaned using long handled brushes and/or vacuum systems utilizing rotary cleaning heads. In addition, holes may be drilled into various systems that act as points of entry to spray latex or acrylic based micro-bioside coatings for the prevention of micro-biological growth. Such a method is believed to be physically intrusive, damaging, inefficient and labor intensive. By spraying a coating through drilled holes, it is believed that the distance between holes and the angles of entry may necessarily prevent certain areas from being coated. This method is believed to be inefficient and incomplete. Many times the ductwork simply has to be replaced due to inaccessibility of areas for treatment.

In order to prevent mold growth on materials of construction, applications of arsenic, creosote and other dangerous and toxic chemicals have often been used to coat the surfaces or pressured into substrates of wood. This type of wood preservation is not believed to be desirable for many applications such as internal use in habitable structures. The wood for habitable construction normally would not be expected to contain volatile organic compounds which may dissipate into the air of the structure or otherwise leech chemicals into the environment with people.

When cleaning and restoring wooden decks, wood siding or wood shake roofs, etc., preferred chemicals of use include oxalic acid, tri-sodium phosphate, chlorine bleach, sodium hydroxide, potassium hydroxide and various other cleaners typically containing ingredients such as ethylene glycol mono-butyl ether, surfactants sequestering agents, chelating agents, phosphates and other water miscible solvents. Use of these various chemical agents are believed to have at least some disadvantages. Oxalic acid is believed to be poisonous to humans and toxic to the environment. Tri-sodium phosphate adds phosphates to water aquifers, lakes and streams and is believed to be harmful to aquatic life by increasing algae growth. Chlorine bleach is known to be corrosive to metal and other surfaces of and around those being cleaned, potentially harmful to the applicator via skin contact and/or inhalation. Furthermore, it is believed to be particularly harmful to vegetation. Sodium hydroxide and potassium hydroxide are also known to be corrosive to many surfaces, to the applicator and/or to vegetation around the application site.

Accordingly, a need has been demonstrated above for the improvement of téchnolog and techniques to sterilize, clean, rejuvenate, restore, remediate, revitalize, bleach and/or remove and/or destroy and/or prevent contaminants and pathogens from inanimate building surfaces and air environments.

### SUMMARY OF THE INVENTION

It is an object of the present invention to provide a method of sterilizing, cleaning, rejuvenating, restoring, remediating, revitalizing, bleaching, removing, destroying and/or preventing contaminants and pathogens from surfaces and/or environments.

It is another object of the present invention to provide methods of remediating mold and/or other microorganisms and/or pathogens from interior and/or exterior structures and environments.

It is another object of the present invention to clean and restore water and/or sun damaged surfaces, such as wood back toward original color, with or without prevention of mold regrowth in interior and/or exterior structures or environments.

It is another object of the present invention to provide methods for remediating mold and/or spores from HVAC systems, pneumatic systems, air ventilation systems, air handling systems, piping systems, and/or otherwise difficult to access areas.

It is another object of the present invention to prevent mold growth and/or regrowth on construction materials.

It is another object of the present invention to provide a method of cleaning and/or restoring wood such as wood decks, wood siding, wood shake roofs, etc., in an improved manner.

It is another object of the present invention to provide a method of restoring roofs and/or siding.

It is a further object of the present invention to not be limited in scope to include killing, sterilizing, disinfecting, sanitizing, cleaning and removing biofilms, biomass, pathogens and other contamination from bathrooms, kitchens, food processing locations, food storage locations, food preparation areas, interior and exterior areas of structures, etc.

It is another object of the present invention to provide an improved method for penetrating and/or dissolving biofilms and killing and/or removing contaminants including microorganisms and pathogens therein.

It is an other object of the present invention to provide a method of destroying and/or removing biofilms, biomass, and/or other contaminants from a surface that eliminates a need for a wiping step as is done in the prior art methods.

It is a further object of the present invention to reduce the time and labor required to accomplish killing, destruction, disinfection and/or sanitizing or cleaning.

In the presently preferred embodiments, a solution of hydrogen peroxide (H2O2) possibly in combination with ozinated water is contemplated to be applied preferably by mechanical spraying, misting, fogging, etc., to bio films and/or other mold infested, soiled, faded and/or stained surface or environment to which the treatment is applied to attempt to sterilize, clean, and/or bleach the surfaces preferably to remove mold growth and/or spores and/or other microorganisms and their spores and/or pathogens. Fogging, misting, painting, wiping, rolling, pouring and more preferably spraying of a freshly generated ozinated water solution in conjunction with a second solution containing hydrogen peroxide with the pH preferably 0 to 14 and most preferably about 3.5 and preferably sufficient surfacants and wetting agents present so that contaminants are, by reaction with the contaminants, “foamed out” of unwanted locations.

After treatment with the hydrogen peroxide solution, the treated area should be allowed to dry for a period long enough to reduce moisture content of wood or other water absorbing materials to roughly about below 20% and/or wait a sufficient time for drying. This invention using the above techniques is currently performed in conjunction with HEPA vacuuming and not wiping of the treated surfaces. Vacuuming alone after drying has been found to remove most treated contaminants. For complete removal of areas of heavy visible growth, mild brushing along with reapplication of the solutions may be helpful. After removing the treated contaminants, it is preferred in some embodiments that a liquid siloxane anti-microbial or other microbial coating may be applied to provide ongoing anti-fungal and/or anti-bacterial effects. After coating surfaces, air in the space may be scrubbed using HEPA filtered air scrubbers. Preferably dehumidifiers may be utilized to control humidity levels. Typically a period of twenty-four hours of dead air time has been found helpful for heavy than air particles to settle before calling for post remediation testing. The above techniques have been found to require less time and labor affording superior results than current industry practices

Mechanical equipment such as a rotating power driven fog machine may be utilized for various applications of the solutions. Hand sprayers or other equipment may also be utilized as will be understood by one of ordinary skill in the art.

### DETAILED DESCRIPTION OF THE PREFERRED EMBODIMENT

The presently preferred embodiment of the invention provides methods to assist in treating through cleaning, killing, destroying and/or eliminating biomass which is defined herein as mold, mildew, spores, algae, microorganisms pathogens, and/or mycotoxins on inanimate surfaces and in the air. Other contaminants may also be addressed by the methods taught herein. In the preferred embodiments, the process provides long-term prevention of mold, mildew, spores, algae, and microorganisms, pathogens and mycotoxins on inanimate surfaces. Additionally, in at least one of the preferred embodiments, remediation and restoration of bare wood and other cellulosics towards their original color has been observed. Furthermore, remediation of HVAC and other air handling systems can also be provided utilizing preferred embodiments. Treatment of structures can occur with various solutions such as a first step involving a hydrogen peroxide solution preceded by, followed by or in conjunction with a solution containing a catalyst such as ozinated water and/or other activating agents which is fogged, misted, painted, rolled, poured, foamed and/or any other method of application but preferably sprayed onto a surface to be treated. Activating agents could include destabilizers such as iron, calcium, magnesium, etc. Additionally, a post treatment solution may be applied to treated surfaces after removing treated contaminants to reduce the propensity that such contaminants might return in the future as will be discussed in further detail below.

Specifically, hydrogen peroxide such as from 3% to 75% and more particularly, from 10% to 35% and still more particularly yet, about 17.5% to 20% solution has been utilized as a preferred agent in the preferred embodiment. The hydrogen peroxide solution has been found to at least partially dissolve biofilms, kill microorganisms, sterilize surfaces, clean surfaces, rejuvenate surfaces, restore surfaces, remediate surfaces, revitalize surfaces and bleach surfaces. In the context of sterilization, over 9% hydrogen peroxide solution (H2O2) has been found adequate in some embodiments to provide sterilization capability with sterilization being defined as being 100% of microbial kill. pHs preferably 0 to 14 and most preferably about 3.5 have been found preferable. Low pHs in conjunction with low levels of hydrogen peroxide inhibitors and/or stabilizers have necessitated providing the hydrogen peroxide solution in vented containers as if a contaminant were to enter the container, off gassing of oxygen (O₂) would be a likely hazard in a sealed container.

In addition to hydrogen peroxide, a surface tension reducer and/or wetting agent is preferably added to the solution to aid in penetration of biomass and porous substrates along with a foaming agent so that peroxide activity yields a visual aid or marker where viable biomass is present. A catalyst such as activating agents such as iron and/or O to 20% Ozone (O₃) and/or UV light have also been utilized to assist in a one or two step process as will be explained herein. While use of hydrogen peroxide throughout the pH range of 0 to 14 could be employed, it is presently preferred that the pH range be in a range of about 3.5 and be directed at surfaces of sufficient strength to kill microorganisms, bleach, restore, remove biofilm, pathogens and/or clean inanimate surfaces. Additives may also be provided to assist in killing microorganisms and to restore surfaces. Furthermore, as to cleaning surfaces the preferred method has been found that the hydrogen peroxide solutions can dissolve, strip remove waxes, cross-linked polymers and other coatings from floors and other surfaces.

In applying the hydrogen peroxide solution, spraying, fogging, foaming, rolling, brushing, wiping, mopping, misting, pouring, air spraying, pressurized spraying and/or spraying the hydrogen peroxide solution may be utilized to assist in killing microorganisms, bleaching, cleaning, restoring and/or restoring. After spray treatment with the hydrogen peroxide solution, the next step may be to wipe, brush, pressurize spray air, pressure spray solutions and/or vacuuming the treated surfaces to remove spores, microorganisms, soils, and/or other treated contaminants.

Instead of blasting biofilm found in low pressure water lines and other water lines, tanks, sewer lines, drains and other surfaces exposed to microorganisms with a first high pressure baking soda solution, or other compounds the use of concentrated hydrogen peroxide solution has been found to be more effective at attacking large colonies and/or groups of colonies and other entrapped soils which are contained in the biofilm coating.

In addition to treating with concentrated hydrogen peroxide, a micro-biocide coating can be applied in a subsequent treatment to prevent re-growth of microorganisms on inanimate surfaces and/or substrates. It is preferred that the micro-biocide be a clear liquid type which may be sprayed, painted, rolled and poured on surfaces, such as building surfaces, to be treated and can be fogged into spaces which preferably kills airborne spores if still present and being heavy than air will precipitate to lower surfaces. It is further advantageous to provide an ultra-violet indicator or other indicators so that the coverage may be evaluated to ensure the proper application. Other indicators could also be utilized. A liquid, permanent and/or semi-permanent breathable or non-breathable coating may also be utilized with a colorant to ensure proper coverage during application.

Applications of the coatings performed by means of spraying, fogging, misting, etc., especially into HVAC systems, pneumatic systems, air ventilation systems, etc., have been particularly effective. Fogging and/or misting on inanimate surfaces such as walls, floors, ceilings, recesses and/or other areas to kill and prevent growth of microbes have also been found to be effective. Fogging and misting also have been found to attach to airborne particulates including those containing spores to assist in treating such airborne particulates.

When vacuuming or otherwise removing air, it is preferable to use HEPA filtered systems to assist in removing spores, microorganisms and other contaminants.

Instead of wiping the surface with disinfectants to kill and remove mold, the application of concentrated hydrogen peroxide particularly as a spray, but including mist and/or foam or other applications, have been found to be a preferred method of treating interior and/or exterior surfaces and/or airborne contaminants. The hydrogen peroxide in appropriate strengths is believed to have a broader kill capability and is more efficient at microbial removal than traditional disinfectants while cleaning and restoring surfaces. A hydrogen peroxide solution, which foams profusely upon contact with microorganisms and certain other soils, the applicator obtains a visual indication of the location of living contamination and thus can concentrate their efforts on those. Applying the hydrogen peroxide solution via such methods, mold spores and/or bacteria can be killed on contact and this process is believed to be more effective with the added benefit of bleaching and stain reduction on celulosic material than wiping with a disinfectant soaked rag. Furthermore, the violent foaming dislodges contaminants from the substrate and boils them to the surface for removal along with the loosened surface contamination.

After application, if necessary, allow the treated surface to dry to a sufficient degree the operator may use a vacuum such as one fitted with a HEPA filter and preferably a brush head to vacuum the surfaces which have been treated to assist in removing material remaining on the surface. By vacuuming it is possible to achieve complete removal of all contaminants from the surface in the presently preferred embodiment.

Prior art mold treatments are believed to rely around high pressure soda and ice blasting followed by a rinse with diluted low-level hydrogen peroxide. Hydrogen peroxide has been applied AT a pH of 6.5 or greater and further diluted through a traditional pressure washer. Pressure washers are typically used to remove very heavy fungal growth prior to any other surface treatments. This method contributes large amounts of unwanted water to the space being cleaned. This often requires wet vacuuming of the excess water and the implementation of dehumidifiers to get the space back to optimum remediation conditions and/or long term drying times.

Instead of highly diluted hydrogen peroxide, higher concentration, Typically low pH solution preferably with concentrations in a range of about 3% to about 70% and more preferably about 10% to 35% or even around 20% such as 17.5% has been found to be preferable by the applicant. Such concentrations are not believed to have been used with prior art techniques. Furthermore, due to expense, dangers, reactivity, handling requirements, etc. of the reactive hydrogen peroxide solution used by the applicants and the harsh environment created during application, it is not believed to have been commercially attempted by others before.

When applying the micro-biocide solution, it is preferably fogged in or sprayed without dilution; when fogged it has been found to remove airborne particulate in less than 24 hours which is believed to be much more efficient than using HEPA air filters and air scrubbers for a minimum of 72 hours. Fogging an air space coats airborne spores with microbiocide, thus killing them and since the coated spores are now heavier than air, they precipitate from the air rendering these free of spores and other contaminates. By fogging micro-biocide into an airborne environment, the production time is reduced by at least two thirds of the former time which is a huge efficiency and time saving tool. In actual tests, a treated house had a lower concentration than air outside the house.

As it relates to HVAC systems and other air systems, instead of having to drill holes and use spray guns from access point drillings which can be somewhat inefficient and incomplete due to the angular relationship, etc., the applicant coated interior surfaces of air handling systems by applying a fog, mist or spray of the anti-microbial solution to the air system. A coating of all interior surfaces with the anti-microbial solution was accomplished. This has been found to result in no need to replace any of the ducting since all portions of it can be treated. Furthermore, it is not intrusive to the physical structure and it can significantly reduce labor costs. Furthermore, portions of the air system can even be utilized to assist in transporting the fog or mist throughout the system.

When cleaning and restoring wooden decks, wood siding or wood shake roofs, etc., preferred chemicals of use include oxalic acid, tri-sodium phosphate, chlorine bleach, sodium hydroxide, potassium hydroxide and various other cleaners typically containing ingredients such as ethylene glycol mono-butyl ether, surfactants, sequestering agents, chelating agents, phosphates and other water miscible solvents. Use of these various chemical agents are believed to have at least some disadvantages. Oxalic acid is poisonous to humans and toxic to the environment. Tri-sodium phosphate adds phosphates to water aquifers, lakes and streams and is believed to be harmful to aquatic life by increasing algae growth. Chlorine bleach is known to be corrosive to metal and other surfaces of and around those being cleaned, potentially harmful to the applicator via skin contact and/or inhalation. Furthermore, it is believed to be particularly harmful to vegetation. Sodium hydroxide and potassium hydroxide are also known to be corrosive to many surfaces, to the applicator and/or to vegetation around the application site. By products of concentrated volatile hydrogen peroxide solution are H₂O, O₂ and low levels of other harmless oxides.

When applying hydrogen peroxide solution to surfaces having wood to be cleaned or restored, the solution eliminates mold, mildew, bacteria and their spores and pathagens and many stains along with potentially reversing the “aging” effect of sun caused on the surface of the wood without adversely affecting the integrity of the wood. Furthermore, little if any toxic material is believed to be provided to the environment when applied to wood surfaces since during the process of cleaning and bleaching the wood hydrogen peroxide (H₂O₂) degrades into oxygen and water.

Biofilms are often attache das groups of micro-organisms to a surface that are harder to kill and/or remove from these surfaces than unattached micro-organisms due to the presence of a slimy and/or glue like carbohydrate coating. Biofilms are typically removed with biocides, acids and hypchlorites that may or may not be followed by a de-chlor then rensied by low levels of diluted hydrogen peroxide (less than 3% solution and diluted with water during application). Hypo-chlorite, usually the sodium salt, is often preferred over hydrogen peroxide for many applications including biofilm removal because it may be more effective at lower levels. For many cleaning and disinfection applications, large amounts of water and low chemical levels may be preferred to balance cost with efficiency.

Instead of using a high concentration of water, which then must be removed and dried, the applicant proposes using high concentrations of hydrogen peroxide solution with PREFERABLY an acidic pH to kill, remove and deodorize biofilms without contributing biocides, chlorides, phosphates and other contaminates to the environment.

Furthermore, after treatment the treated contaminant waste is vacuumed to remove debris. It is also possible to coat the treated construction with a permanent or semi-permanent coating containing an anti-microbial and in some embodiments it is a clear breathable coating which can also contain an indicator such as a dye, pigment, tint or a UV indicator, etc. The coloring is helpful to visually indicate areas of coverage.

The applicant envisions utilizing a fog, spray, mist, paint, rolling process, and/or pouring or otherwise applying by spraying, fogging, etc., an optional ozinated water solution before or after or together with a hydrogen peroxide solution onto a surface potentially contaminated with mold, mildew, algae, micro-organisms, pathogens, soil, faded and/or stained surface and/or space for the purpose of sterilizing, cleaning, removing, and/or bleaching as a part of the mold remediation process.

Of course, personnel working in the space should be fitted with proper personnel protection equipment (PPE) while applying the hydrogen peroxide solution. Normally, this would include a full body suit to cover the feet and hooded to cover the entire head except for the face, chemical resistant gloves and a full-face respirator with two filter cartridges rated for hydrogen peroxide and spores. It is further advised that no one should enter the work area without proper PPE. When spraying or fogging or otherwise applying the hydrogen peroxide solution whether or not it contains the ozinated water solution or other activators or whether or not this solution is provided as a pretreatment, simultaneously or in conjunction with the hydrogen peroxide, oxygen is expected to be released. Oxygen can be explosive at certain levels in an atmosphere. All sources of ignition should be extinguished, shut off and/or removed from the treatment area. Positive and negative ventilation is preferred during the application process of the hydrogen peroxide solution. As living organisms are destroyed, the byproducts will be oxygen, water and possibly carbon dioxide. Adequate ventilation is preferably continued about an hour after the application of the solution. This added ventilation is believed to assist in clearing the air of excess gasses and will help in reducing moisture from the environment. The various embodiments of applying solution include the utilization of only hydrogen peroxide solution alone on the surface through the application of mechanical spraying and/or fogging. A second option involves the use of the application of hydrogen peroxide in conjunction with or immediately followed by the application of at least one of a catalyst and an activator such as a highly ozinated water solution.

Regardless of the order, the ozinated solution, if utilized, acts as a catalyst that will cause the hydrogen peroxide to generate large amounts of hydroxyl radicals which will then attack the living organic matter to destroy the organisms. Creation of enough radicals can change the physical state of the molds and spores into water, oxygen and carbon dioxide and debris. Furthermore, when the applied hydrogen peroxide solution foams, it can show where reactions are occurring. It is preferred that a minimum space of time occur between the hydrogen peroxide treatment and the ozinated water treatment due to the normal rapid breakdown of ozone.

A user applying the solution can see the visible effects of this reaction by the profuse foam that may be generated as a result of the reactions. The generation of foam due to hydrogen peroxide reaction with catalase and other enzymes in and around living organisms is a somewhat A unique characteristic that sets this method of remediation and identification apart from current arts. Since the user knows where contamination is located, he or she can return to those areas previously treated to test for latent reactive areas. Specifically, the user can reapply at least one solution until foaming stops to verify sterilization. Foaming has a secondary effect in that it assists in mechanically boiling contamination from crevasses to the surface where it can be removed. When there is visible mold damage some materials may be removed and replaced, but many areas may be sprayed and scrubbed with a brush and then vacuumed to assist in physically removing the growth and contamination as it boils up in the foam.

Applying the hydrogen peroxide to a contaminated surface dissolves and releases the biomass causing it to be unattached so it can be easily removed with a vacuum such as a HEPA vacuum.

Additionally, the space may be allowed to dry for a period of time long enough to reduce moisture content of wood and other water absorbing materials typically below 20% so that soil may be easily removed by vacuuming. Since the hydrogen peroxide solution is concentrated and not diluted with water, there is not the excess quantities of water as in prior arts. High levels of moisture have been found to prevent proper penetration and coating of an anti-microbial. Upon completion of the hydrogen peroxide application, vacuuming and/or air drying steps, the surfaces are believed to be ready for an application of an optional anti-microbial barrier coating which will be described in further detail below.

Various mechanical sprayers as are known in the art may be utilized to mechanically spray anti-microbial coatings. Of course, mechanical fogging machines such as one now known On a rotating power driven table may also be utilized. Fogging and/or spraying may be performed so that the desired surfaces are coated. When a visual indicator is utilized such as a colorant or UV indicator, visual observation may be sufficient. As it relates to fogging, depending on the concentration of hydrogen peroxide solution, it may be extremely dangerous (i.e., remember the propellant status of concentrated H₂O₂ discussed above) it should be done with careful consideration to explosion hazards.

After treating the surface with hydrogen peroxide solution with or without the ozinated water catalyst, the treated surface may be allowed to dry for a sufficient period of time and/or checked with a moisture meter and/or visual indicator in applied solutions (i.e., an applied solution may dry from one color to another at a particular moisture content). When reaching a desired level of dryness, the treated surface is preferably vacuumed. During the drying step, after the treating step with hydrogen peroxide, all ventilation may be stopped such as by sealing so that no outside air can enter the space. This would prevent intrusion of outside air into the space so that the only spores left in the space would be the dead.

Even dead organic matter can still emit micotoxins which can cause allergies and/or disease in persons. Removal of the dead mold spores is usually important. Vacuuming the surfaces with a vacuum system preferably fitted with a HEPA filtration system can remove the mold spores and other contaminates and prevent them from reentering the space. The HEPA filter preferably catches or retains organic matter. An external vacuum system can be utilized so long as the vacuum system is positioned downstream of the structure being treated.

After removal of contaminants, application of a anti-microbial coating may be applied which may include resins or other substances such as siloxane IN A anti-microbial coating which prevent the growth of mold on surfaces. Anti-fungal or anti-bacterial agents may be included in an anti-microbial coatings. Once again, a power operated spray apparatus, pressurized spray tank, garden type sprayer, fogger or other device could be utilized to propel a liquid siloxane anti-microbial coating onto surfaces in the remediated area. The microbial coating is believed to provide a permanent long-term (such as at least ten years for internal surfaces) protection against mold and bacterial growth and/or regrowth. This coating can contain an ultraviolet indicator tag or color or colorants for purposes of quality control in a somewhat similar manner as the hydrogen peroxide solution or otherwise. After coating the surfaces, the air in the space is preferably scrubbed using a HEPA filtered air scrubbers. It is further preferred that while the HEPA air scrubbers are running dehumidifiers are operated to control air humidity to at least below 40%. Twenty-four hours after completing air scrubbing the space may be left undisturbed such as at least twenty-four hours before post remediation tests are normally conducted.

When fogging devices are utilized to apply the anti-microbial coatings. Since spores that are coated in the air with a fogging machine will fall out of the air, this method can be performed without long periods of air scrubbing or dehumidifying. A period of twelve hours after completing the fogging procedure may be all that is needed before any post-remediation testing is conducted. After completion of post remediation testing, the horizontal surfaces where spores could settle may be vacuumed to remove precipitated contaminants. This should comply with currently accepted goals for removal of all micro-organisms whether viable or non-viable.

This anti-microbial coating can also be applied internal to an HVAC system or other air handling systems preferably by fogging which could preferably create small such as 5 to 30 micron particles to coat the plenums, air ducts, piping or other parts of the internal surfaces of the air systems.

During initial construction of a structure, it is possible to pretreat the structure with the anti-microbial coating. The anti-microbial coating should be applied after the structure is dried in (roof and sides in place). This pretreatment can preclude much growth of micro-organisms to thereby prevent possible damage to the structure.

In some applications, it has been found that a concentrated hydrogen peroxide solution can not only kill mold on wood but it can also eliminate oxidation from wood surfaces and assist in revitalizing wood colors. Utilizing a concentrated hydrogen peroxide solution such as with a pressurized spray tank, pump up garden type sprayer, or otherwise, the solution would be applied to molding and/or oxidized wood. This process is believed to assist in returning wood to its original color and/or be microbe free. Various solutions depending on the particular application can be created and a solution of concentrated hydrogen peroxide and other components in the preferred treating solution. A first example of the solution is provided below:

| Chemical | % |
|---|---|
| Hydrogen peroxide | 3-75% |
| Surfactants* | 0-20% |
| Chelates** | 0-20% |
| Sequestrants*** | 0-20% |
| Other Additives**** | 0-20% |
| Water | q.s. |

*Should be stable to H2O2 and typical surfactant classes would include amine oxides, fatty alcohol alkoxylates, etc.
**Small molecular weight poly organic acids, their salts, phosphates, etc.
***Large molecular weight poly organic acids, their salts, phosphonates, etc.
****Buffers, pH modifiers, Epson Salt, solvents, etc.

If utilizing an ozinated water catalyst for the above, it can preferably be constructed of ozone and water.

The siloxane based anti-microbial coating is also provided in its presently preferred formula below:

| Chemical | % |
|---|---|
| Siloxane and/or resin | 0-90% |
| Solvent | 0-40% |
| Surfactant and/or wetter | 0-20% |
| Benzododeconium chloride | 0-20% |
| Miristalkonium chloride | 0-20% |
| Coco alkyl dimethylbenzyl | 0-20% |
| ammonium chloride | |
| 5-Chloro-2-methyl-2 H- | 0-20% |
| isothiazol-3-one | |
| 2-Methyl-2 H-isothiazol-3-one | 0-20% |
| 5-Chloro-2-methyl-4- | 0-20% |
| isothiazolin-3-one | |
| Biphenyl-2-ol | 0-20% |
| Colorant | 0-5% |
| Hidden Indicator* | 0-5% |
| Water | 0-99.5% |

*Such as an optical brightener that can be identified under UV light.

The siloxane based anti-microbial should have the following attributes:
1. A water clear solution to prevent discoloration or staining of any surface. Surfaces such as carpet, upholstery, curtains, fabric, sheet rock, acoustical ceiling tiles, mattresses, etc. could be treated with the anti-microbial solution for long term protection against microbial growth without staining, discoloring, tinting, coloring, or otherwise changing the visual appearance of the surface or substrate.
2. Of a viscosity similar to water so that the anti-microbial solution will penetrate into the substrate for deep long term protection against microbial growth.
3. Upon drying the anti-microbial solution should remain flexible so as to maintain the integrity of the coating on all surfaces and in the substrate of porous materials.
4. The anti-microbial solution should contain less than 1% solids with water being the preferred carrier to minimize volatile organic compounds that could possibly be released into the interior environment of structures.
5. The anti-microbial solution should be a breathable coating. It should not form a continuous film such as paint. A breathable coating will allow water to transport in and out of the substrate without trapping. The substrate will then be allowed to expand and contract with changes in humidity and will be able to expel large amounts of absorbed water.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A method of treating a potentially contaminated space comprising:
applying a concentrated hydrogen peroxide solution exceeding at least three percent hydrogen peroxide to a first location selected from a first building surface and an air space;
waiting a predetermined time and vacuuming at least one of the first building surface and an area below the air space

2. The method of claim 1 further comprising the step of applying at least one of a catalyst and an activator to the first location no more than thirty minutes before applying the concentrated hydrogen peroxide solution to the first location.

3. The method of claim 2 wherein the catalyst solution comprises one of an ozinated water solution.

4. The method of claim 2 further comprising an ultraviolet light indicator in at least one of the catalyst and the hydrogen peroxide solution.

5. The method of claim 1 wherein the hydrogen peroxide solution is at least 9% hydrogen peroxide and the pH is below about 4.

6. The method of claim 4 wherein the hydrogen peroxide solution is at least 17% hydrogen peroxide and the pH is about 3.5.

7. The method of claim 1 further comprising the step of applying an anti-microbial coating to the first location after applying the hydrogenated peroxide solution to the first location.

8. The method of claim 6 wherein at least one of the anti-microbial coating and the hydrogen peroxide solution have an indicator therein selected from the group of dyes, tints, pigments, and ultraviolet light indicators.

9. The method of claim 1 further comprising the step of ventilating the first location at least one of during and after applying the hydrogen peroxide solution.

10. The method of claim 1 wherein the hydrogen peroxide solution further comprises at least one of a wetting agent and a surfactant and the hydrogen peroxide solution foams upon contact with a biomass component.

11. The method of claim 1 wherein the hydrogen peroxide solution contains a corrosion inhibitor and the corrosion inhibitor reduces a tendency of the hydrogen peroxide solution to attack at least metals.

12. The method of claim 1 wherein the treatment with the hydrogen peroxide solution performs at least one of bleaching, removing stains, and oxidizing the first location.

13. A method of claim 1 further comprising the step of at least one of at least partially removing and cleaning wax, acrylic cross link and polymer coatings and soils from floors and other surfaces with the hydrogen peroxide solution.

14. A method of treating a potentially contaminated space comprising:
applying a concentrated hydrogen peroxide solution exceeding at least three percent hydrogen peroxide and having a pH below 6 to a first location selected from a first building surface and an air space to provide a treated first location; and
allowing the treated first location to dry one of a predetermined time and below a predetermined moisture level; and then
applying an anti-microbial coating to the first location.

15. The method of claim 13 further comprising the step of vacuuming after allowing the first location to dry the one of the predetermined time and below the predetermined moisture level.

16. The method of claim 13 further comprising the step of applying at least one of a catalyst at least one of before, after and with the hydrogen peroxide solution.

17. The method of claim 15 wherein the catalyst further comprises ozone.

18. The method of claim 13 wherein the hydrogen peroxide solution further comprises a surfactant and the hydrogen peroxide solution foams upon contact with a biomass.

19. The method of claim 17 wherein the first location is wood and the peroxide solution restores the wood towards an original color.

20. The method of claim 17 wherein the hydrogen peroxide solution further comprises a wetting agent.

21. The method of claim 13 wherein the hydrogen peroxide solution contains a corrosion inhibitor and the corrosion inhibitor reduces a tendency of the hydrogen peroxide solution to attack at least metals.

22. The method of claim 17 wherein during the step of foaming at least microscopic amounts of at least one of biomass and other contaminants on surfaces are detected.

23. The method of claim 17 further comprising the step of lifting at least one of soils, biomass, biofilms, pathogens and other contaminants from substrates selected from the group of grout, ceramic tile, ceramics, cement materials, air intrained materials, and other porous surfaces through the effervescent foaming effects at least partially caused from reactions with the hydrogen peroxide solution.

24. The method of claim 22 further comprising the step of having the hydrogen peroxide solution break surface tension, penetrate and release soils on the surface.

25. A method of treating a potentially contaminated space comprising: applying a concentrated hydrogen peroxide solution exceeding at least three percent hydrogen peroxide and having a pH below 6 to a first location selected from a first building surface and an air space to provide a treated first location, with said solution having at least one of a wetting agent and a surfactant, and said solution configured to foam upon contact with a biomass; and allowing said solution to dry at least one of a predetermined time and below a predetermined moisture level.

26. The method of claim 25 further comprising the step of vacuuming after allowing the solution to dry and the applied hydrogen peroxide has a pH below about 4.

27. The method of claim 25 further comprising the step of applying at least one of an anti-microbrial solution and coating after allowing the first building surface to dry to at least one of a predetermined time and a predetermined moisture level.

28. The method of claim 25 wherein the treatment further comprises at least one of sterilizing, disinfecting, sanitizing, releasing attached debris, and removing debris from the space.

29. The method of claim 25 further comprising the step of applying at least one of a catalyst and an activator one of at, before and after applying the hydrogen peroxide solution.

30. The method of claim 25 further comprising the step of providing a de-stabilizer to the hydrogen peroxide solution thereby providing an active hydrogen peroxide solution.

31. The method of claim 25 wherein the space further comprises a biofilm connected to the surface and further comprising the step of disrupting an integrity of the biofilm with at most minimal mechanical agitation.

32. The method of claim 31 wherein during the step of disrupting the biofilm, a release of at least one of biomass and other contaminants are released form the biofilm as released debris, and during the step of vacuuming, the released debris are removed from the surface.

33. The method of claim 26 further wherein during the step of applying the concentrated hydrogen peroxide solution, mycotoxins with proteins present in the space, have proteins which are at least one of chemically and steriologically altered to be ineffective, at least one of enzymatically and pathogenically.

34. The method of claim 26 wherein the application of the hydrogen peroxide solution is performed through at least one of spraying, wiping, foaming, soaking, rolling, fogging, brushing, mopping, misting, pouring and painting the hydrogen peroxide solution to the surface to be treated.

35. The method of claim 25 wherein the hydrogen peroxide solution has less than 20% of at least one of stabilizers and inhibitors, and the at least one of the stabilizers and inhibitors increase the reactivity of the hydrogen peroxide solution and reduce selectivity of reaction sites during the step of the application of the hydrogen peroxide solution.

36. The method of claim 35 wherein the solution further comprises a de-activator which reduces at least one of stabilizers and inhibitors thereby increasing reaction sites and providing increased potential for foaming effects.

37. A method of removal of at least one of biofilms, biomass and pathogens from a surface with the application of a treatment solution and vacuuming in the absence of wiping the surface.

38. The method of claim 37 wherein the treatment solution further comprises hydrogen peroxide.

39. The method of claim 38 further comprising the step of brushing at least some portions of the surface prior to vacuuming.

40. A method of treating a surface with about 3% to 75% hydrogen peroxide solution wherein a commercially available technical grade solution is obtained and at least 0.001% inhibitors are added prior to treating the surface thereby increasing an ability to remove at least one of biofilms, biomass, pathogens and debris.
